(19) United States
(12) Patent Application Publication
(10) Pub. No.: US 2003/0011527 A1
(43) Pub. Date: Jan. 16, 2003

(54) Apparatus for electromagnetic spectroscopy

(76) Inventors: Boris Ivanovich Kokorin, Vraznek Per (RU); Leonid Vladimirovich Waisser, Eperjes U (RU)

Correspondence Address: YOUNG & THOMPSON, 745 SOUTH 23RD STREET 2ND FLOOR, ARLINGTON, VA, 22202

(21) Appl. No.: 10/009,838

(22) PCT Filed: Apr. 10, 2001
(86) PCT No.: PCT/ZA01/00040

(30) Foreign Application Priority Data
Apr. 15, 2000 (ZA) 2000-1319

(51) Int. Cl. H01Q 11/12; H01Q 7/00

(52) U.S. Cl. 343/742; 343/744; 343/866

(57) ABSTRACT

Apparatus for creation of multidimensional and/or multidirectional electrical and/or magnetic fields for analysis or for treatment of a desired component of a specimen comprises a number of solenoid elements which are arranged in predetermined shaped structures to provide complicated patterns of inhomogeneous oscillating electrical and/or magnetic fields and whose configurations cause constant change in the direction of the fields so that each part of the apparatus has a field sector which has a different direction.

### TECHNICAL FIELD OF THE INVENTION

This invention relates to apparatus for electromagnetic spectroscopy with special reference to the creation of multi-dimensional and/or multi-directional electrical and/or magnetic fields for the analysis of substances and/or the exposure of substances to predetermined electric and/or magnetic fields; as well as for transmission and receiving antennae for communications.

### BACKGROUND OF THE INVENTION

The use of toroidal windings as electromagnetic radiating antennae is known, for example through U.S. Pat. Nos. 4,622,558, 4,751,515, 5,442,369 and 5,654,723. The teachings of these patents bas been used to provide apparatus using super-toroidal windings for generating and using the resulting electromagnetic fields for example, as a means of communication and also as a means of analysis of substances and of exposing substances to predetermined electromagnetic fields.

A super-toroidal conductor is one in which the windings of a toroidally-wound conductor are constituted by helical windings. This provides a field generator having at least one super-toroidal conductor and which has means to energise the conductor to generate varying electric and/or magnetic fields. If the frequency is equal to or greater than 2c/l (c being the speed of light in free space, and l is the length of the super-toroidal conductor), the near field will have a strongly inhomogeneous spatial distribution similar to or more complex than that generated by four or mere electric charges and/or current loops.

The super-toroidal apparatus may include first, second or third order windings which comprise, in the first order, a long helically coiled conductor wound around a toroidal former; in the second order the conductor is replaced by a long helically coiled conductor; and in the third order the second order winding is replaced with a long helically coiled conductor.

Super-toroidal apparatus is described in our co-pending RSA Patent Application No. of even date. Such apparatus is centered around the toroidal shape of the former, while the present invention is directed away from the toroidal nature of the windings with advantages which will be discussed below.

### DISCLOSURE OF THE INVENTION

According to the present invention apparatus is provided for creating or receiving or using a variety of electric and/or magnetic fields, the apparatus including one or more solenoid elements which are, or are adapted to be formed into a variety of configurations corresponding with certain electrical and/or magnetic fields.

In addition the apparatus may include means to periodically vary the homogeneous fields produced.

In one form of the invention a plurality of solenoid elements is provided which may be arranged in parallel and/or series and it is envisaged that shaped structures such as spheres, semi-spheres, cylinders, cones, cubes, triangles or many other geometric or non-geometrical configurations may be formed. These forms may be in the nature of a cage. The particular configuration may be designed to provide a predetermined field or fields depending on the use to which it is to be put.

The apparatus should be energised with at least one frequency component equal to or greater than 2c/l where c is the speed of light in free space and l is the length of the solenoid conductor/s. Then the near field generated at this frequency close to the solenoid conductor will have a strongly inhomogeneous spatial distribution similar or more complex than that generated by four or more electric charges and/or current loops and that at any particular moment in time, the amplitudes of the electric and magnetic fields components of such a complex field change significantly over a distance comparable with the smallest winding feature of the solenoid conductor. Such a strongly inhomogeneous field can be distinguished from the classic electromagnetic fields produced in the prior art.

The invention also provides a detector for electric and magnetic fields comprising at least one solenoid conductor and means responsive to electrical currents generated in said conductor by varying electric and magnetic fields.

Examples of the invention provide a sample analyser comprising a chamber, and a sample holder within the chamber. The chamber contains at least a first solenoid conductor having at least the length l. This solenoid conductor is energised to generate oscillating electric and magnetic field in the region of any sample on the sample holder. The electromagnetic field varies with a frequency component equal to our greater than 2c/l to produce a strongly spatical inhomogeneous field. Then the response of the generated field to the presence of a sample on the sample holder is determined, so that an analysis can be made.

The invention also provides treatment apparatus for treating a desired component of a specimen. The apparatus comprises a treatment solenoid conductor having a length l. The treatment solenoid conductor is energised at a frequency or set of frequencies or continuous band of frequencies greater than 2c/l to produce strongly inhomogeneous electric and magnetic fields. The specimen is exposed to this field and the frequency or set of frequencies or continuous band of frequencies is selected to provide the required treatment of the desired component of the specimen. In order to select the required frequency or set of frequencies or continuous band of frequencies for treatment, a sample corresponding to the desired component of the specimen to be treated may be analysed in the above described sample analyser. The treatment frequency or set of frequencies or continuous band of frequencies is then selected in accordance with the response determined in the sample analyser. In this way, treatment of predominantly or only selected components of a specimen can be ensured by incorporating a sample of the desired component in the associated sample analyser.

For treatment purposes the electric and/or magnetic field may be modulated by a low frequency signal within a band of from 0.001 to 1000 cycles per second.

The apparatus may be used as an antenna for transmission or receiving of signals or fields in communications.

In another application of the invention the apparatus may be used to determine the inherent frequency of a substance, such as a chemical substance, a geological specimen, a living organism or fluid and many other substances.

A substance may be exposed to the electrical and/or magnetic fields as determined by the analysis, and the invention has utility in the treatment of bacteria, viruses and other micro organisms or even the DNA molecule itself. Such fields may be varied periodically at a predetermined frequency.

The apparatus of the invention is capable of detecting the constitution of substances having electric and/or magnetic multipolar moments. In this way liquid samples, for example, which would only produce uninformative broad radio frequency absorption spectra in purely dipole electromagnetic fields, can produce much more information absorption spectra in the strongly spatially inhomogeneous fields generated in the apparatus of the invention.

The sample to be analysed may be located in an enclosure which is located within the configuration of an apparatus according to the invention. The sample is treated by exposure to the particular electric and/or magnetic fields generated by the apparatus and a typical absorption spectrum is obtained.

The host substance may then be exposed to a field corresponding to the absorption spectrum. In the case of a body fluid containing unwanted micro organisms, for example, the field generated will be in resonance with the natural frequency of the micro organism with the result that the latter can be destroyed or affected at suitable intensities.

Without wishing to be bound by the following dissertation on the mathematics which may be involved, it seems that the classical Maxwell equations may be considered as in the presence of an external electric current.

$$c u r l E = - \frac{1}{c} \frac{\partial H}{\partial t} \\ d i v E = 4 πρ \\ d i v H = 0 \\ c u r l H = \frac{1}{c} \frac{\partial E}{\partial t} + \frac{4 π}{c} j \qquad ( 0.1 )$$

The charge density and the current density satisfies the following relationship:

$$\frac{\partial ρ}{\partial t} + d i vj = 0 \qquad ( 0.2 )$$

From now on we will consider the closed currents, which satisfies the condition divj=0. Such currents can produce the rotational electric field.

Let us consider simplest case of the electric current, which is linear function of time, i.e. j,=jₗ(t/ [symbol] ). As it follows from the Maxwell equations (1) such an external current produces the magnetic field with the same time dependence, H=H₁(t/ [symbol] ) as a static electric field, which is described by the following equations:

$$c u r l E = - \frac{1}{c τ} {H}_{i} \\ d i v E = 0 \qquad ( 0.3 )$$

That is the external sources of the linearly varying (in time) electric current produces the static electric field, which satisfies the same equation as a static magnetic field, which is produced by the by a time-independent electric current. In order to achieve one-to one correspondence we can introduce “magnetic current” jₘ=H₁/4 [symbol] [symbol] , which allows us to arrive at

$$c u r l E = - \frac{4 π}{c} {j}_{m} \\ d i v E = 0 \qquad ( 0.4 )$$

Here the magnetic current is not a result of the averaging of the microscopic sources as happens for the electric current, but arises only as a redefinition of the non-stationary macroscopic electric currents. Correspondingly, it can be employed for describing the macroscopic objects allowing to interpret their interaction with electromagnetic field by using the invariance of the Maxwell equations with respect to the substitutions E [symbol] H, H [symbol] -E, j_{c} [symbol] jₘ, jₘ [symbol] -jₒ, [symbol] _{z} [symbol] [symbol] ₘ, [symbol] ₘ [symbol] - [symbol] ₐ, where j_{e,m} and [symbol] _{e,m} are electric and magnetic current and charge density, respectively.

Let us consider, for example, a field of the ideal solenoid, in which linearly varying external electric current j=jₗ(t/ [symbol] ) is flowing. Inside the solenoid (r<α) we have a uniform magnetic field, H=Hₗ(t/ [symbol] ), and azimuthal electric field,

$${E}_{θ} = - \frac{r}{2 c τ} {H}_{i} \qquad ( 0.5 )$$

Outside the solenoid (r<α) only electric field survive

$${E}_{θ} = - \frac{1}{2 c τ} {H}_{i} \frac{{a}^{2}}{r} = - \frac{2 π}{c} {j}_{m} \frac{{a}^{2}}{r} \qquad ( 0.6 )$$

which coincides formally with the field of the magnetic current

$${I}_{m} = \int {j}_{m} d s = \frac{{a}^{2}}{4 τ} {H}_{i} \qquad ( 0.7 )$$

(One can compare this equation with the correspondent equation for the magnetic field, which is generated by a linear electric current). Now we can compress the solenoid into a line, leaving unchanged the product α²Hₗ/ [symbol] =const and arrive at the static electric field in all space except r=0. In terms of the electric current this means that jₗα² [symbol] / [symbol] =const, where [symbol] l is the thickness of the winding of the solenoid. Correspondingly, jₗ [symbol] l =j_{surf} is the surface current flowing in the solenoid. This parameter can be expressed as j_{naf}=nI, where n is the number of the turns per unit length along the solenoid axes and I gives the electric current flowing in the solenoid, I_{solenoid}=I(t/ [symbol] ).

Therefore, we have shown, that solenoid, in which external electric current varies linearly with time, represents the macroscopic magnetic current, which produces a static electric field.

The apparatus of the invention creates highly complicated patterns of highly inhomogeneous oscillating electric and/or magnetic fields and the configurations cause constant change in direction of the fields so that each part of the apparatus, (or antenna) will have a magnetic field sector which has a different direction. Following the Maxwell equations, the magnetic field of the oscillating current gives rise to a magnetic field, and/or oscillating current gives rise to an oscillating electric field with the electric field sector being directed differently in the different parts of the antenna. The pattern of fields becomes even more complex at high frequencies when the current in the antenna is not more homogeneous and alternates along the wire of the antenna. A typical inhomogencousity of the field is similar to the size of the structural elements of the winding, i.e. in the range of millimeters.

There are several observations to be made.

Multipole interactions are roughly (α/L)^{n.1} times weaker than dipole interaction. Here n is the order of multipole, α is typical size of the molecule and L is typical inhomogencousity of the field. For example for an organic molecule of α-10⁻⁵ cm and L ˜10⁻¹ cm quadruple interactions will be 10000 times weaker than dipole interaction. Therefore multipole interaction is only important for molecules with zero dipole moment or when there the field is highly inhomogeneous;

the bigger the size of the molecular structure the more efficient will be the multipole interaction. For example CH₄ molecule of 10⁻⁷ cm size will experience a 10000 time weaker quadrupole force than a 10μ microrganism with similar distribution of charges.

Molecular systems which show high-order multipole momenta of charge distribution but do not have lower momenta are expected to have highly symmetrical “shapes”. In a viscose, liquid environment a much smaller torque will be necessary to provide angular acceleration (rotation) for a highly symmetrical molecule than for a highly asymmetrical polar molecular with pronounced dipole moment.

Consequently the absorption and refraction spectra obtained with use of the apparatus of the present invention can be distinctively different from the spectra seen in conventional radio frequency spectroscopy. In the case of complex mixture of molecules of different sorts, the spectra will include contributions from a wider range of molecules, in particular molecules having only high-order multipole moments of charge distribution; this may give different spectra in comparison with conventional forms of spectroscopy.

Stimulation of matter, in particular organic liquids and suspension of living organisms with the apparatus of the present invention will excite a broader range of molecules and therefore may be different from stimulation with homogeneous fields.

In this specification the term “substance” is used in its widest sense and includes chemical substances such as chemical compounds and compositions as well as elemental substances. The apparatus may be adapted to activate or deactivate a chemical reactions; or to inhibit such reactions. The apparatus may also be adapted to act as a catalyst.

There are many other possible uses of the apparatus of the invention, including the potentiation and/or control of fermentation reactions such as in viniculture, beer brewing, yeast manufacture and many others.

Further amplification and variation of field may be obtained by providing solenoids of various orders. Thus, a simple solenoid may be regarded as a first order solenoid; whereas a second order solenoid may be constituted by a second solenoid wound around a first solenoid. A third solenoid wound around the second solenoid will constitute a third degree solenoid structure, and so on to the nth degree.

### EMBODIMENTS OF THE INVENTION

Several embodiments of the invention are described below with reference to the accompanying drawings, in which:

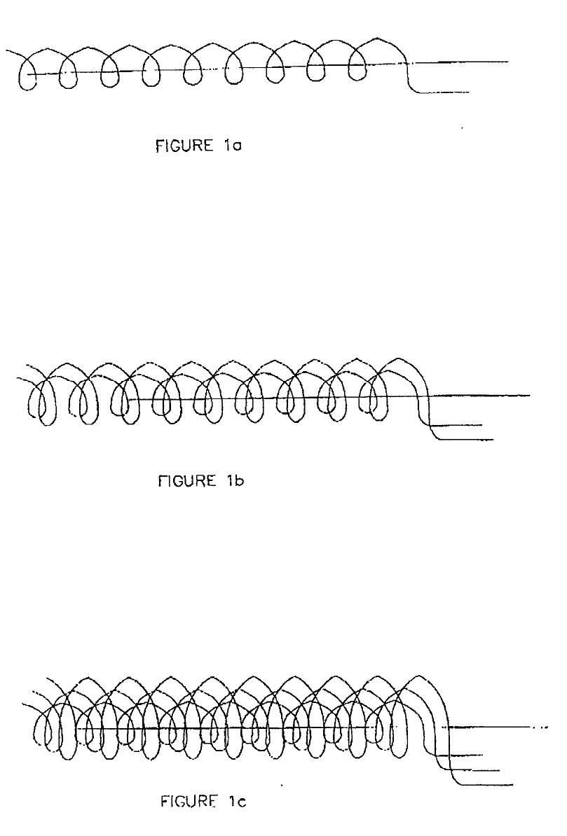

FIG. 1 is a diagrammatic representation of first, second and third degree solenoid structure;

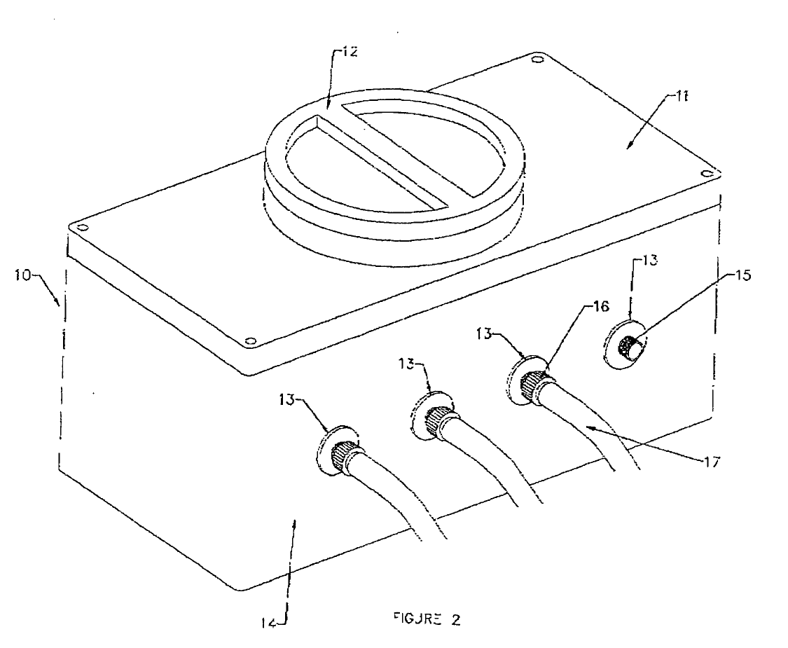

FIG. 2 is an external view of an enclosure used in a simple analyser;

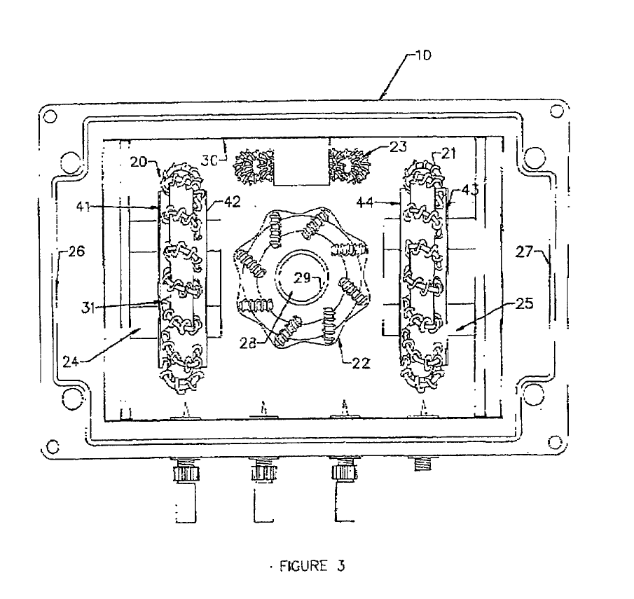

FIG. 3 is a view of the interior of the box of FIG. 2;

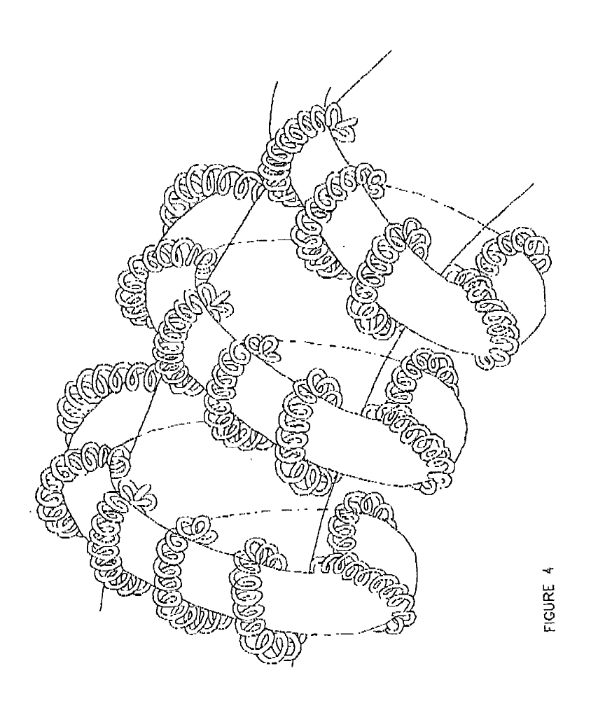

FIG. 4 is an illustration of a third order solenoid structure; and

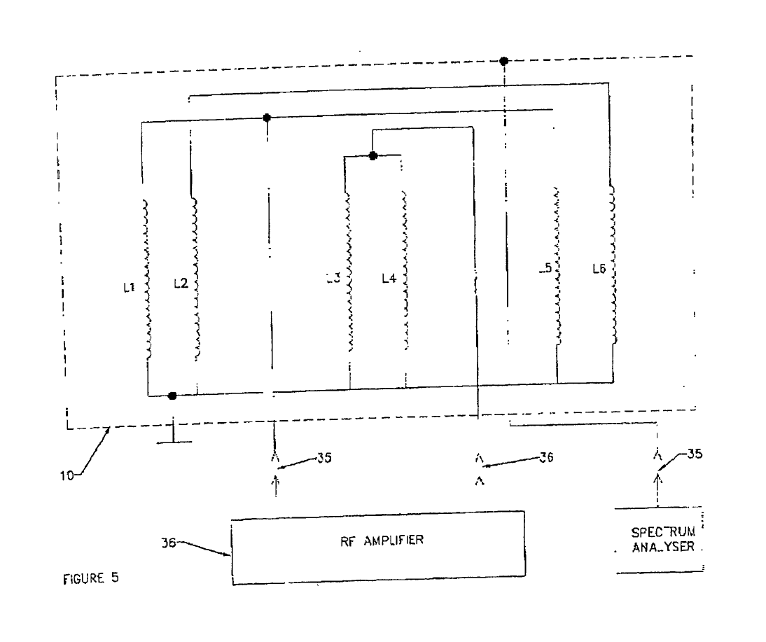

FIG. 5 is a circuit diagram showing the connections of the winding of a combined analysis and treatment apparatus.

In FIG. 1a is shown a conventional form of solenoid whereas in FIG. 1b a second solenoid structure 2b is wound on to the conventional solenoid 2a of FIG. 1, whereas in FIG. 1c a third solenoid structure 2c is wound on to the second solenoid structure 2b.

Referring now to FIG. 2 the enclosure comprises a box 10 having a removable lid 11 constituting one face of the box. A hatch 12 is provided in the lid for easy access to the interior of the enclosure. The enclosure is made of metal and is intended to provide electromagnetic screening of the interior of the box. Feedthroughs 13 are provided for electrical signals through a front face 14 of the box and include coaxial electrical sockets 15 for selective engagement with corresponding coaxial plugs 16 on coaxial connecting cables 17.

FIG. 3 illustrates the interior of the box 10 with the lid 11 removed. The box contains four solenoid structures 20,21,22 and 23. The assemblies 20 and 21 are mounted on respective dielectric mounting blocks 24 and 25 so as to be essentially parallel to opposite upright end faces 26 and 27 of the box 10.

Substantially midway between the assemblies 20 and 21 a sample tray 28 is mounted on the bottom face of the box 10. Sample tray 28 provides a flat base with an upstanding rim 29 sized so as accurately to locate a removable sample holder on the tray 28 within the box. As shown in the figure, the assembly 22 is located around the base of the sample tray 28, so that any sample placed in a container upon the tray 28 lies substantially on the axis of the solenoid 22.

The fourth solenoid structure 23 is mounted so as to be parallel to the rear face 30 of the enclosure, and midway between the opposed assemblies 20 and 21.

Each of the assembles 20 and 21 comprises a combination of a second order solenoid structure and a third order solenoid structure. In effect, the third order solenoid structure formed on a former constituted by a second order solenoid structure. Thus, a solenoid 31 for each of the assembles 20 and 21 comprises third order solenoid structure such as illustrated in FIG. 4. As illustrated in FIG. 4, the third order solenoid structure may be formed from a tightly wound helical spring of insulated wire, which is itself then wound round in a helix of greater diameter.

In constructing the assemblies 20 and 21, the second order solenoid structure is stabilised by wrapping in a heat shrinkable material and then used as the former for a third order super solenoid structure. The third order solenoid of FIG. 4 may be formed from a tightly wound helical spring of insulated wire, which spring is itself wound into a helix of greater diameter. This doubly wound helical formation is then wound around a helical solenoid structure which is in turn wound around the former of the third order solenoid structure; and then formed into a desired configuration.

The assembly 22 comprises a simple third order solenoid structure wound on a dielectric solenoid former, and the solenoid conductor assembly 23 is a second order solenoid also wound on a dielectric solenoid former.

The various windings of the assemblies within the enclosure formed by the box 10 are illustrated diagrammatically in FIG. 5. In the Figure, L1 represents the third order solenoid structure of an assembly 20, and L2 represents the second order solenoid forming the former of the third order winding in assembly 20. Similarly, L6 represents the third order winding of assembly 21 on the solenoid constituted by the second order solenoid L5. L3 represents the third order solenoid winding 22 and L4 represents the second order solenoid winding 23.

As can be seen, the outer third order winding L1 of the assembly 20 is connected in parallel with the inner second order winding L5 of assembly 21 and fed via a feedthrough 35 from the box 10 to the input of a broad band rf amplifier 36. The output of the broad band amplifier 36 is fed back through a second feedthrough 37 into the box 10 to the third order winding L3, forming the assembly 22 connected in parallel with the second order winding L4 forming the assembly 23.

The inner second order winding L2 of the assembly 20 is connected in parallel with the outer third order winding L6 of the assembly 21 and fed via a further feedthrough 38 to an analyser 39.

With the above construction, the windings within the box 10 together with the high gain broad band radio frequency amplifier 36 form a closed loop. If the gain of the rf amplifier is sufficient, the loop gain at particular frequencies will exceed unity producing oscillation at these frequencies. Also, oscillation at other frequencies may be generated due to non-linearity of the circuit. The frequencies at which oscillation is occurring can be monitored by the analyser 39 which is preferably a spectrum analyser.

In a particular embodiment, the broad band radio frequency amplifier is type HP8347A from Hewlett-Packard and the spectrum analyser 39 is type 8599E also from Hewlett-Packard.

It has been found that the arrangement disclosed above produces rf oscillations over a wide spectrum extending from a relatively low frequency up to 3 Ghz or more. The system produces a spectrum of oscillations, detected by the analyser 39. Depending on the tuning of the system, which may be achieved by adjustments of the positions of the solenoid antennas, lengths of the rf leads and the amplifier gain, the spectrum has peaks at discrete frequencies over this frequency range or comprises of a combination of discrete frequencies and continuous bands of frequencies. It has been found that the distribution of these frequency peaks and/or bands is dependent on the nature of a sample material located in a container on the tray 28 in the centre of the box 10. Typically, the sample may be a fluid sample and the quantity (volume) of the fluid sample and the dimensions of the container to be located on the tray 28 are maintained constant so that the features in the output spectrum dependent on the internal geometry of the enclosure 10 remain consistent for different samples.

By virtue of the apparatus of the invention a wide and very useful database may be obtained relating to a variety of substances, whether by way of artificial signal or by self-excitation.

It has also been found that the location of the solenoid elements in a liquid crystal medium results in a substantial amplification to produce fields to the nth degree. The relevant mathematics in this regard will be added when completed.

1. Apparatus for creating or receiving or using a variety of electric and/or magnetic fields characterised in that a plurality of solenoid elements is provided which are in, or are adapted to be arranged in predetermined shaped structures to provide one or more highly complicated patterns of highly inhomogeneous oscillating electric and/or magnetic fields depending on the use to which they are to be put, and whose configurations cause constant change in the direction of the fields so that each part of the apparatus will have an electric and/or magnetic field sector which has a different direction.

2. The apparatus according to claim 1 characterised in it includes means to periodically vary the homogeneous field or fields produced.

3. The apparatus according to claim 1 or claim 2 characterised in that the shaped structures are chosen from spheres, semi-spheres, cylinders, cones, cubes or other geometric or non-geometric configurations.

4. The apparatus according to any of claims 1 to 3 characterised in that the shaped structures are in the form of a cage.

5. The apparatus according to any of the above claims characterised in that the conductor includes a length l and said means to energise is operative to generate an electromagnetic field varying with at least one frequency component at a frequency which is equal to or greater than 2c/l where c is the speed of light in free space.

6. The apparatus according to claim 5 characterised in that near field generated at this frequency close to the solenoid conductor will have a strongly inhomogeneous spatial distribution similar or more complex than that generated by four or more electric charges and/or current loops and that at any particular moment in time, the amplitudes of the electric and magnetic fields components of such a complex filed change significantly over a distance comparable with the smallest winding feature of the solenoid conductor.

7. The apparatus according to any of the above claims characterised in that it includes a detector for electric and magnetic fields comprising at least one solenoid conductor and means responsive to electrical currents generated in said conductor by varying electric and magnetic fields.

8. The apparatus according to any of claims 1 to 6 characterised in that the form of a sample analyser comprising a chamber, a sample holder within the chamber, at least a first super-toroidal conductor in the chamber which includes a length l of the conductor which is wound continuously in the same hand, means for energising said first super-toroidal conductor to generate, in the region of any sample on the sample holder, an electromagnetic field varying with at least one frequency component at a frequency which is equal to or greater than 2c/l where c is the speed of light in free space, and means for determining a response of the generated field to the presence of a sample on the sample holder.

9. The apparatus according to any of claims 1 to 6 characterised in that the form of treatment apparatus for treating a desired component of a specimen, comprising at least one treatment super-toroidal conductor having a length l of the conductor which is wound, continuously in the same hand, means to energise the treatment super-toroidal conductor at least one selected frequency which is equal to or greater than 2c/l where c is the speed of light in free space, so as to generate a strongly spatial inhomogeneous electric and magnetic fields at said frequency, and means to expose the specimen to said generated inhomogeneous field.
